(19) United States
(12) Patent Application Publication
(10) Pub. No.: US 2015/0367818 A1
(43) Pub. Date: Dec. 24, 2015

(54) WIPER DEVICE

(71) Applicant: DONGGUAN HONGYI WIPER CO., LTD., DONG GUAN CITY (CN)

(72) Inventor: YUAN-CHIN KU, NEW TAIPEI CITY (TW)

(21) Appl. No.: 14/311,285

(22) Filed: Jun. 21, 2014

(51) Int. Cl. B60S 1/38

(52) U.S. Cl. CPC B60S 1/3851; B60S 1/3879

(57) ABSTRACT

A wiper device comprises a support unit, a wiper strip, a base and an accessory unit. The wiper strip has a fixing portion and a wiping portion. The fixing portion of the wiper strip is fixed to the support unit. The base is made of plastic and has a main body disposed at the middle of the top face of the support unit. The main body has a first fastening portion. The accessory unit has two side walls. A second fastening portion corresponding to the first fastening portions is disposed at the inner sides of the two side walls. The accessory unit is disposed on the base, the first fastening portion of the base and the second fastening portion of the accessory unit are fastened to each other, such that the accessory unit is fastened to the base.

### BACKGROUND OF THE INVENTION

1. Field of the Invention

The present disclosure relates to a wiper device; in particular, to a wiper device which is easy to assemble and disassemble, not easily damaged, adaptable to different car models, and widely applicable.

2. Description of Related Art

Wipers are mainly assembled at front and rear windshields of cars for wiping away rain water or sludge from the windshields, so as to prevent the rain water or sludge from blocking line of view of the driver and the danger which can result therefrom.

Conventional wipers generally include a support unit, a base, an accessory unit, and a wiper strip. The base is fixed at the middle of the top face of the support unit. The wiper strip is fixed to the bottom face of the support unit. The accessory unit is fastened to the base. The wiper can be installed onto wiper arms of cars through the accessory unit, such that the wiper arm drives the wiper and the wiper strip wipes off the rain water or sludge on the windshield.

However, the base of a conventional wiper is made of metal. The production cost is high, and a complicated fastening structure needs to be installed between the accessory unit and the base. For example, a pressing unit needs to be installed for controlling the fastening procedure, it is not easy to use and makes the accessory unit and the base hard to assemble and disassemble. Additionally, the base is made of metal and the accessory unit is made of plastic. When fastening the accessory unit and the base unit, the fastening structure on the (plastic) accessory unit is easily damaged, resulting in insecure, easily separated fastening between the accessory unit and the base unit.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is to provide a wiper device which has a low production cost, has a simple structure, is easy to assemble and disassemble, and is not easily damaged.

In order to achieve the aforementioned objects, the present disclosure provides a wiper device including: a support unit; a wiper strip having a fixing portion and a wiping portion, wherein the fixing portion of the wiper strip is fixed to the support unit; a base made of plastic and having a main body disposed at the middle of the top face of the support unit, wherein a fastening portion is formed on the main body; and an accessory unit having two side walls, wherein a second fastening portion corresponding to the first fastening portion is formed on the inner side of the two side walls, the accessory unit is disposed on the base, and the first fastening portion of the base and the second fastening portion of the accessory unit are fastened to each other such that the accessory unit is fixed to the base.

The present disclosure has the following advantages. The base of the present disclosure is made of plastic, and so has a low production cost. The base and the accessory unit are fastened by joining the first fastening portion and the second fastening portion. The structure is simplified, and the assembly and disassembly is easy. The second fastening portion of the accessory unit and the first fastening portion of the base are fastened to each other. The fastening structure is not easily damaged, such that the accessory unit and the base can be securely fastened without becoming loose or separated.

Furthermore, the base of the present disclosure is made of plastic. The base and the support unit can be fixed to each other through a fixing block and a fixing hole. The base does not need to be joined to the support unit by stamping, such that the production of the wiper device is simplified and the cost is reduced.

In order to further the understanding regarding the present disclosure, the following embodiments are provided along with illustrations to facilitate the disclosure of the present disclosure.

### BRIEF DESCRIPTION OF THE DRAWINGS

FIG. 1 shows an exploded view of a wiper device according to a first embodiment of the present disclosure;

FIG. 2 shows a perspective view of an assembly of a support unit, a wiper strip and a base of a wiper device according to a first embodiment of the present disclosure;

FIG. 3 shows a perspective view of an assembled wiper device according to a first embodiment of the present disclosure;

FIG. 4 shows a cross-sectional view of a wiper device according to a first embodiment of the present disclosure;

FIG. 5 shows a perspective view of a base and an accessory unit according to a first embodiment of the present disclosure;

FIG. 6 shows a perspective view of a base and an accessory unit from another perspective according to a first embodiment of the present disclosure;

FIG. 7 shows an exploded view of a wiper device according to a second embodiment of the present disclosure;

FIG. 8 shows a perspective view of an assembled wiper device according to a second embodiment of the present disclosure;

FIG. 9 shows a perspective of a base and an accessory unit according to a second embodiment of the present disclosure;

FIG. 10 shows a perspective view of a base and an accessory unit from another perspective according to a second embodiment of the present disclosure;

FIG. 11 shows a perspective of a base and an accessory unit according to a third embodiment of the present disclosure; and

FIG. 12 shows a perspective view of a base and an accessory unit according to a fourth embodiment of the present disclosure.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

### First Embodiment

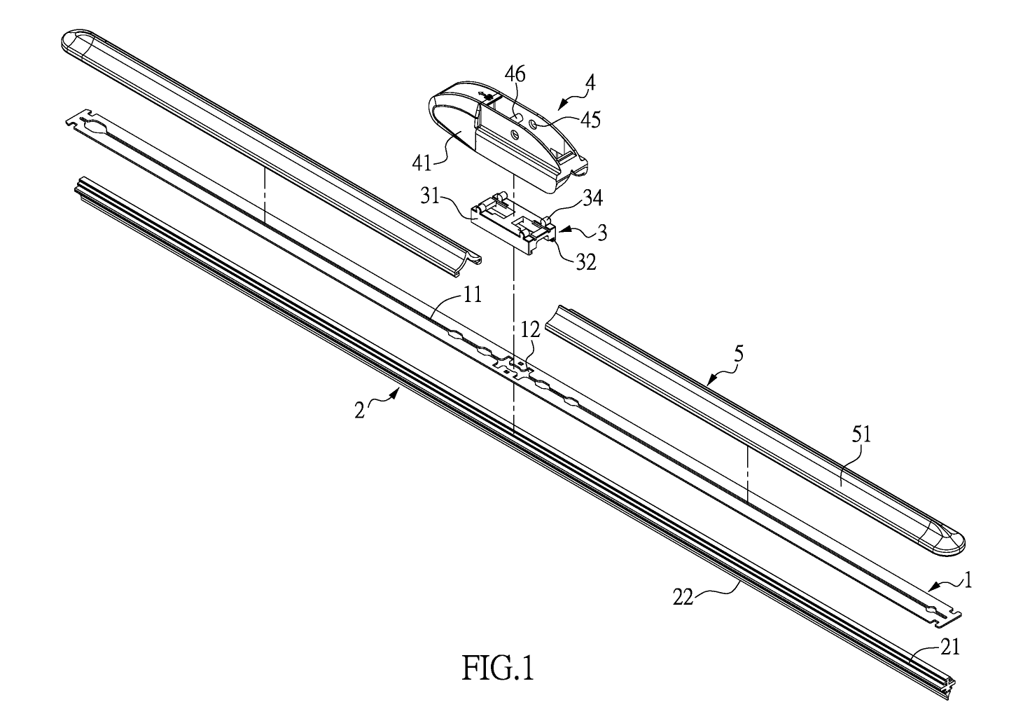

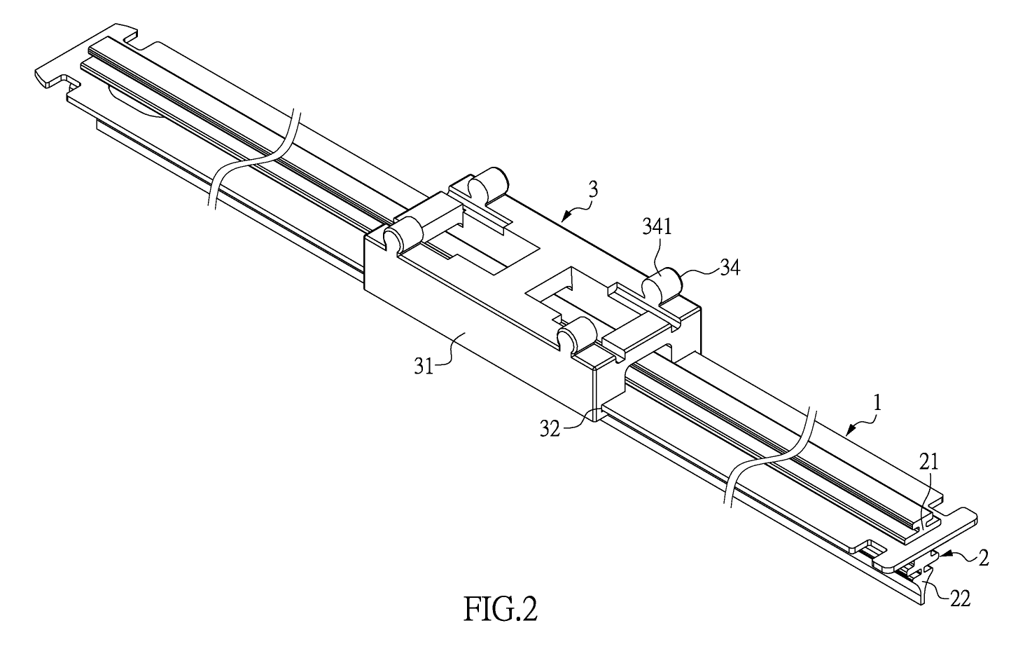

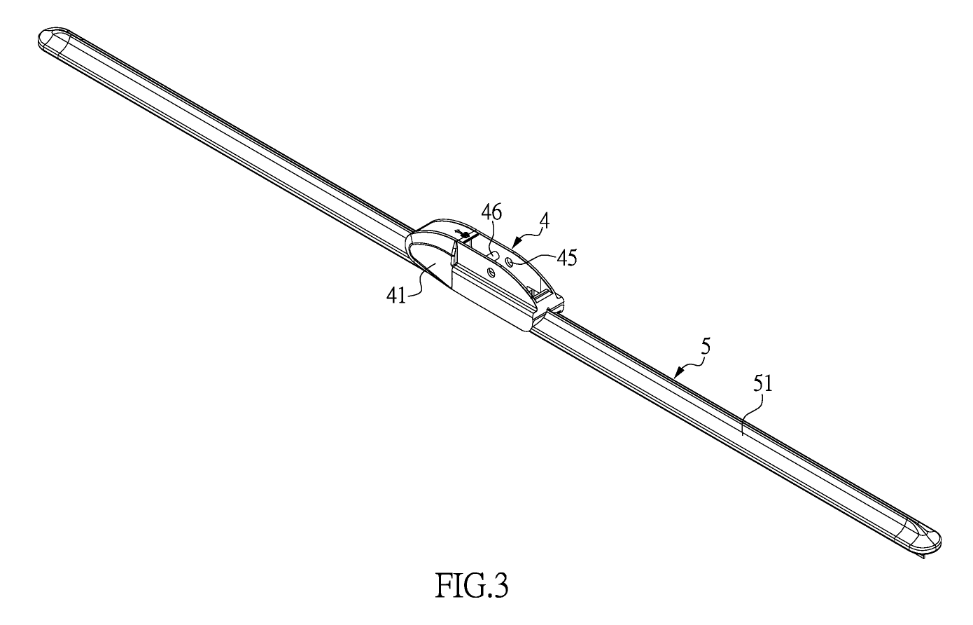

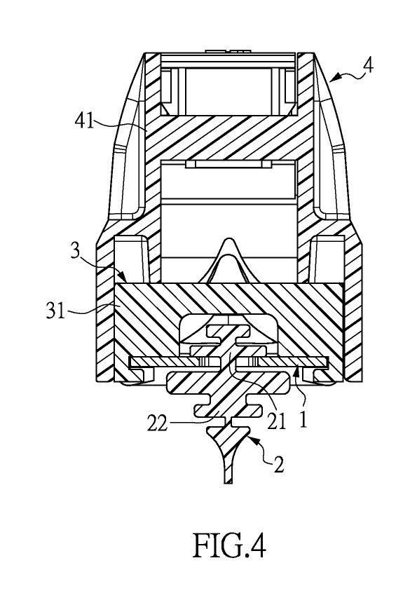

Referring to FIG. 1 to FIG. 4, the present disclosure provides a wiper device, including a support unit 1, a wiper strip 2, a base 3 and an accessory unit 4.

The support unit 1 is a strip-shaped elastic steel sheet which can be bent into a curve. The support unit 1 can be formed with an embedment slot 11 extended along the length-wise direction of the support unit 1. The embedment slot 11 extends to locations proximal to two ends of the support unit 1. The middle of the support unit 1 can be formed with a plurality of fixing holes 12. The fixing holes 12 pass through the support unit 1 from the top face to the bottom face thereof. The fixing holes 12 provides fixture for the base 3.

The wiper strip 2 is a strip-shaped rubber unit. The upper portion and the lower portion of the wiper strip 2 respectively have a fixing portion 21 and a wiping portion 22. The upper edge of the wiping portion 22 is connected to the lower edge of the fixing portion 21. The wiping portion 22 is substantially a triangular strip. The fixing portion 21 of the wiper strip 2 is fixed to the support unit 1. Namely, the fixing portion 21 of the wiper strip 2 can be embedded in the embedment slot 11 of the support unit 1, such that the wiper strip 2 can be fixed to the support unit 1. The wiping portion 22 of the wiper strip 2 protrudes from the bottom face of the support unit 1. However, the structure of the support unit 1 and the wiper strip 2 is generally similar to those of conventional technique, and the present disclosure does not limit the structure of the support unit 1 and the wiping strip 2, so description thereof are not further detailed herein.

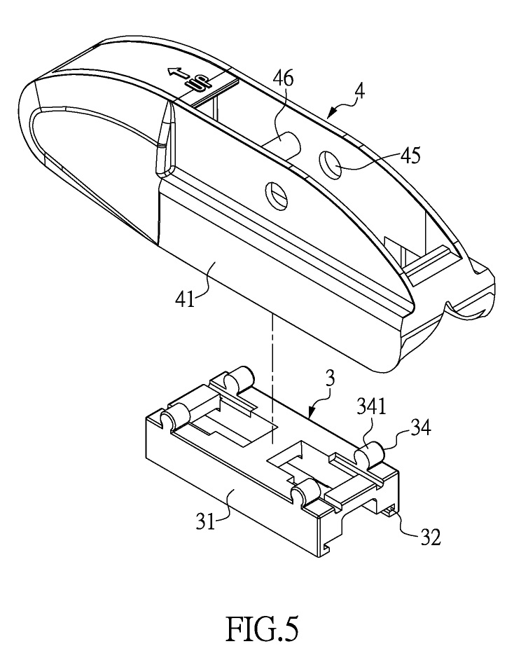

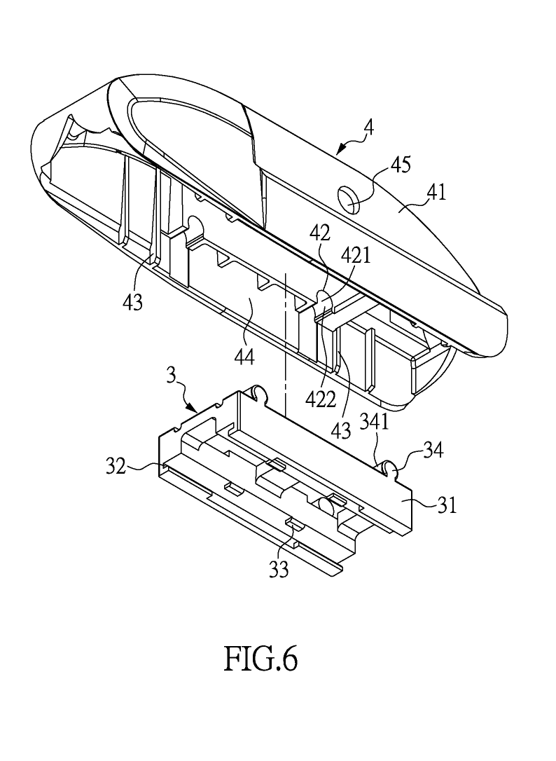

Referring to FIG. 5 and FIG. 6, the base 3 is made of plastic. The base 3 has a main body 31. The shape of the main body 31 is not limited and can be modified according to need. In the present embodiment, the base 31 is overall a cuboid. The main body 31 is arranged at the middle of the top face of the support unit 1. The method of arranging the main body 31 at the support unit 1 is not limited. In the present embodiment, two sides of the bottom portion of the main body 31 are each formed with an engagement groove 32. The two engagement grooves 32 respectively engage two sides of the support unit 1, such that the main body 31 is fixed to the support unit 1. The bottom portion of the main body 31 has a plurality of fixing blocks 33 protruding therefrom. The fixing blocks 33 correspond to the fixing holes 12. When the main body 31 is arranged at the middle of the support unit 1, the fixing blocks 33 and the fixing holes 12 engage and become fixed, such that the base 3 is securely arranged on the support unit 1.

The main body 31 has a first fastening portion 34. The first fastening portion 34 can be a fastening body or a fastening groove. The fastening portion 34 can be disposed at the top face or a side face of the main body 31. In the present embodiment the first fastening portion 34 is a fastening body. The fastening body is cylindrical and horizontally placed. Namely, the first fastening portion 34 is formed with a convex curved face 341. In the present embodiment, four first fastening portions 34 are formed. The first fastening portions 34 are disposed near the four corners at the top face of the main body 31. However, the shape, structure, quantity and location of the first fastening portion 34 are not limited and can be modified according to need.

The accessory unit 4 is preferably but not necessarily made of plastic. The shape and structure of the accessory unit 4 is not limited and can be modified according to need. In the present embodiment, the accessory unit 4 is a generic accessory unit. The accessory unit 4 is a hollow casing having two side walls 41 which are opposite each other. A second fastening portion 42 corresponding to the respective first fastening portion 34 is disposed on the inner side of each of the side walls 41. The second fastening portion 42 can be a fastening groove or a fastening body. In the present embodiment the second fastening portion 42 is a fastening groove. The fastening groove is a circular concave groove and is placed horizontally. Namely, the second fastening portion 42 is formed with a concave curved face 421. The concave curved face 421 is preferably greater than 180 degrees. Namely, two ends of the concave curved face 421 define an opening 422 therebetween. The width of the opening 422 can be smaller than the diameter of the concave curved face 421, for improving the fastening effect. In the present embodiment, four second fastening portions 42 are formed. The second fastening portions 42 are disposed near the bottom of the inner sides of the two side walls 41. However, the shape structure, quantity and location of the second fastening portions 42 are not limited and can be modified according to need.

Two ribs 43 can be disposed at the inner side of each of the side walls 41. Two ribs 43 define a guiding groove 44 therebetween. The second fastening portion 42 is positioned between the two ribs 43. The two guiding grooves 44 correspond to two sides of the main body 31, for guiding the main body to be successfully placed between the two side walls 41, so as to be foolproof.

Additionally, the two side walls 41 can each be formed with a shaft hole 45. A shaft 46 can be arranged between the two side walls 41 for using the shaft holes 45 and the shaft 46 to install the accessory unit 4 onto a wiper arm of a car. Since structure of installation of the accessory unit 4 to a wiper arm of a car is conventional knowledge, and the present disclosure does not limit the structure of the installation of the accessory unit 4 to a wiper arm of a car, the details are not further described herein.

The accessory unit 4 is disposed on the base 3, and causes the first fastening portion 34 of the base 3 and the second fastening portion 42 of the accessory unit 4 to be fastened. Namely, the convex curved face 341 of the first fastening portion 34 can be fastened to the concave curved face 421 through the opening 422 of the second fastening portion 42, such that the accessory unit 4 can be fastened to the base 3. The wiper device can use the accessory unit 4 to be installed to a wiper arm of a car, such that the wiper arm can drive the wiper and through the wiper strip wipe off rain water and sludge on the windshield.

The wiper device of the present disclosure can further include two covers 5. The two covers 5 are strip-shaped and made of rubber. The outer edges of the two covers 5 are each formed with two curved faces 51. The lower parts of two sides of each of the two covers 5 are each formed with a locking groove (omitted in the figures). The two covers 5 are disposed at the top face of the support unit 1. The two covers are locked to two sides of the support unit 1 by the locking grooves, such that the two covers 5 are fixed at two sides of the base 3 on the support unit 1. The two covers 5 cover the support unit 1 for increasing aesthetics and providing protection. The curved faces 51 of the covers 5 also reduces wind resistance when the car travels, and uses the force created by wind resistance to downwardly press the support unit 1 and the wiper strip 2, thereby increasing the efficiency of the wiping portion 22 of the wiper strip 2 to wipe off rain water and sludge.

### Second Embodiment

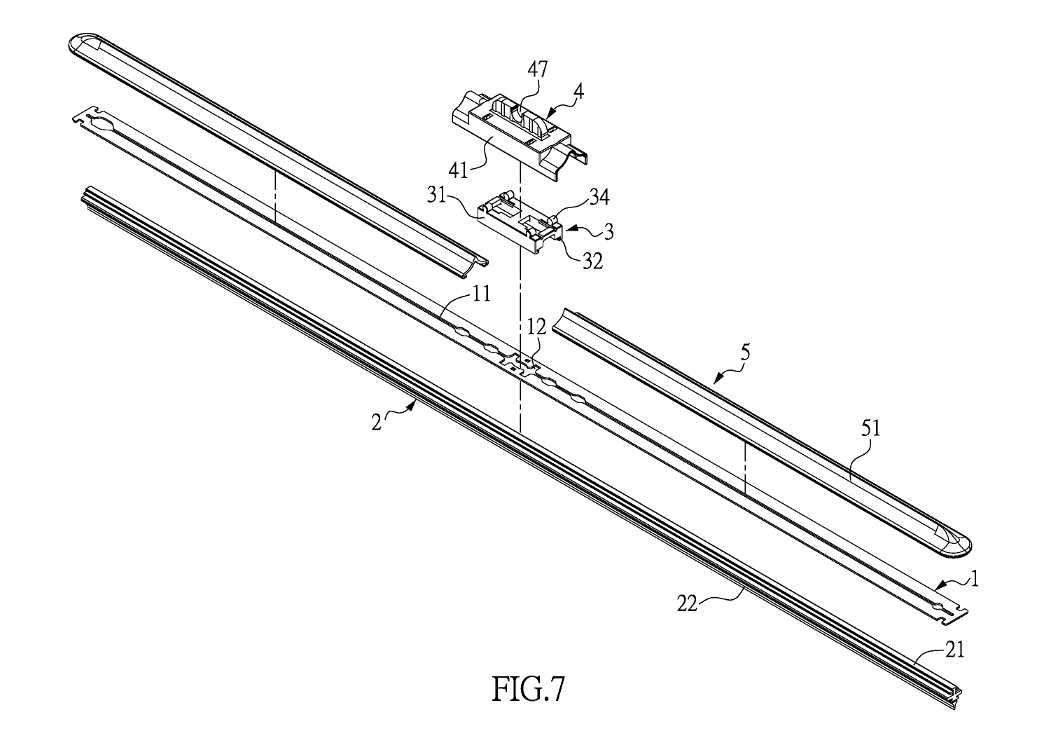

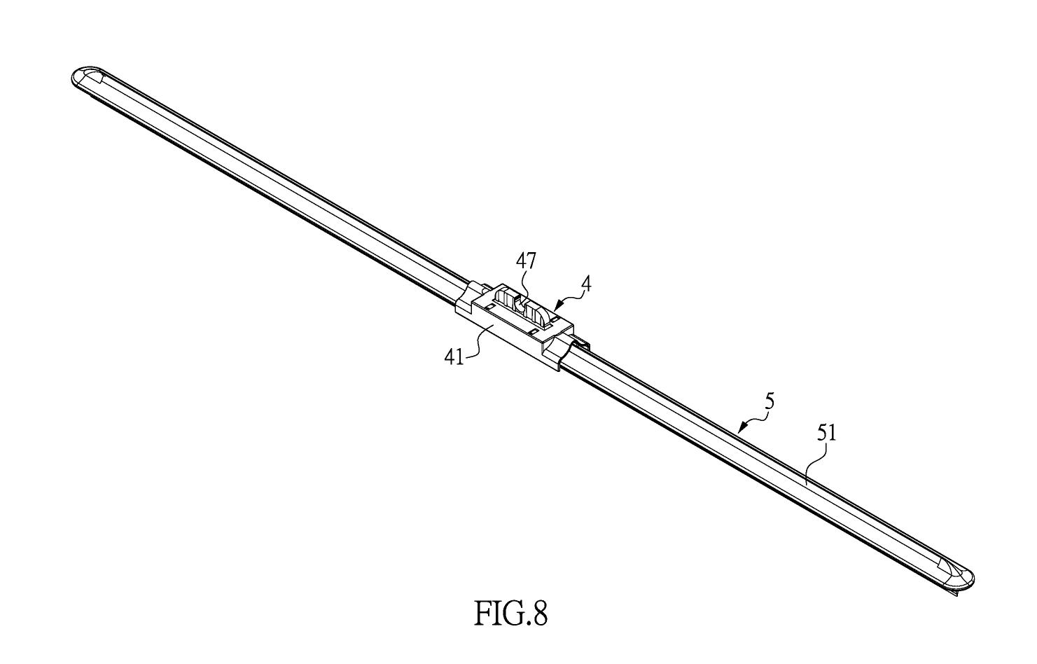

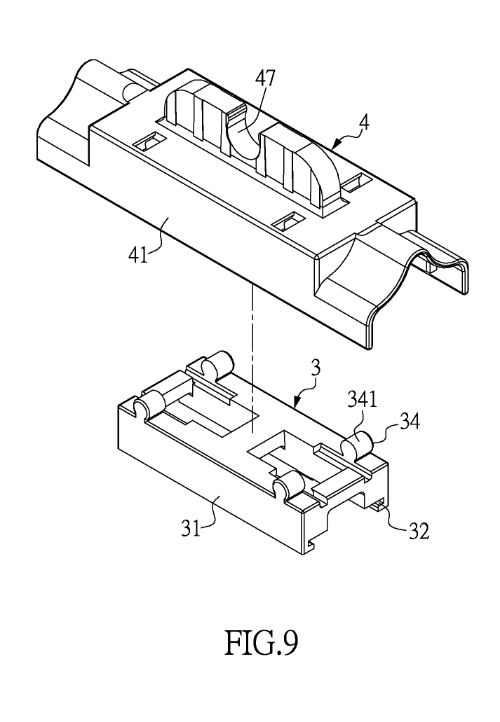

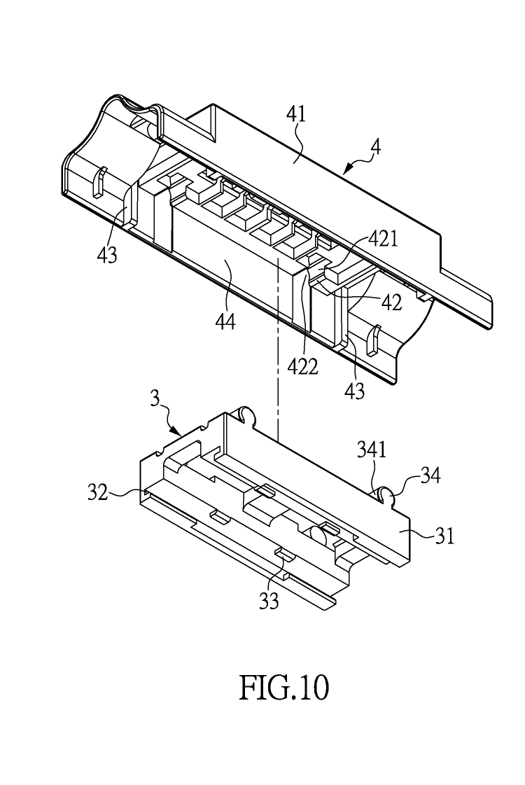

Referring to FIG. 7 to FIG. 10, in the present embodiment the accessory unit 4 is an accessory unit of a specific specification. The shape and structure of the accessory unit 4 are modified, but the inner sides of the two side walls 41 likewise each have the second fastening portion 42 corresponding to the respective first fastening portion 34. The inner side of each of the side walls 41 also has two ribs 43 and a guiding groove 44, for guiding the main body 31 to be successfully placed between the two side walls 41. The external side of the accessory unit 4 is formed with a shaft hole 47, for installing the accessory unit 4 to a wiper arm of a car. The accessory unit 4 is disposed on the base 3, and causes the first fastening portion 34 of the base 3 and the second fastening portion 42 of the accessory unit 4 to be fastened, such that the accessory unit 4 can be fastened to the base 3.

### Third Embodiment

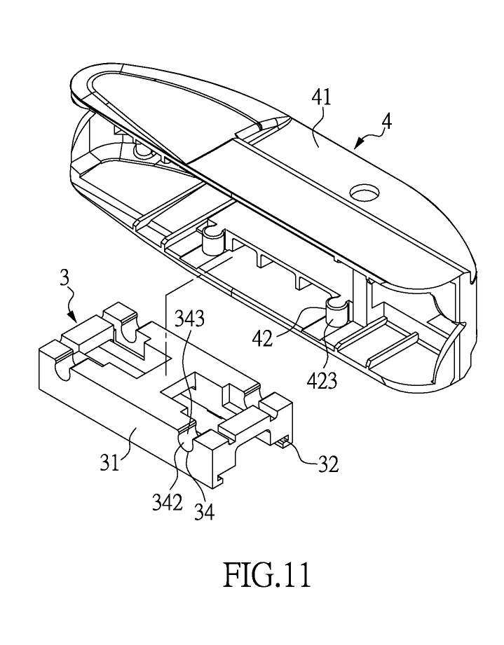

Referring to FIG. 11, in the present embodiment, the first fastening portion 34 is a fastening groove, and the first fastening portion 34 is formed with a concave curved face 342. The concave curved face 342 is preferably greater than 180 degrees. Namely, two ends of the concave curved face 342 define an opening 343 therebetween. The width of the opening 343 can be smaller than the diameter of the concave curved face 342, for improving the fastening effect. In the present embodiment, the second fastening portion 42 is a fastening body, and the second fastening portion 42 is formed with a convex curved face 423. The accessory unit 4 is disposed on the base 3, and causes the concave curved face 342 of the first fastening portion 34 of the base 3 and the convex curved face 423 of the second fastening portion 42 of the accessory unit 4 to be fastened, such that the accessory unit 4 can be fastened to the base 3.

### Fourth Embodiment

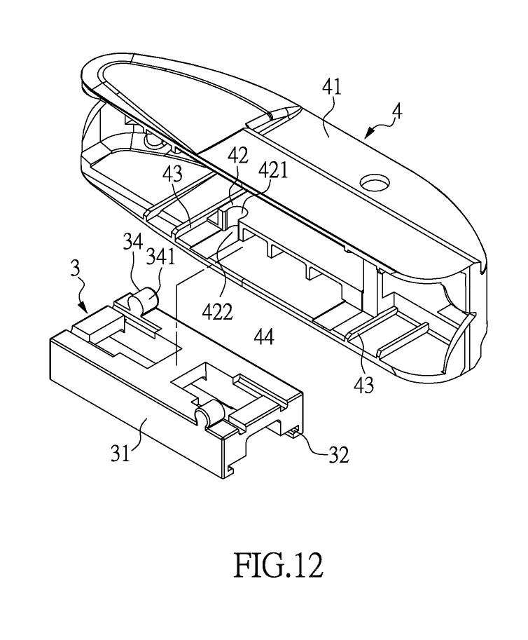

Referring to FIG. 12, in the present embodiment, the quantity of the first fastening portion 34 and the quantity of the second fastening portion 42 are each modified to two. The first fastening portion 34 of the base 3 and the second fastening portion 42 of the accessory unit 4 are fastened, such that the accessory unit 4 can be fastened to the base 3.

The wiper device of the present disclosure has the following advantages. The base of the present disclosure is made of plastic, has a low production cost, and the fastening of the first fastening portion and the second fastening portion between the base and the accessory unit does not require a pressing unit to control the fastening of structures, thereby simplifying the structure and making assembly and disassembly easy. The base of the present disclosure is made of plastic, and the second fastening portion of the accessory unit and the first fastening portion of the base are fastened to each other. The fastening structure is not easily damaged, such that the accessory unit and the base can be securely fastened without becoming loose or separated. The base of the present disclosure is made of plastic. The base and the support unit can be fixed to each other through a fixing block and a fixing hole. The base does not need to be joined to the support unit by stamping, such that the production of the wiper device is simplified and the cost is reduced.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A wiper device comprising:
a support unit;
a wiper strip having a fixing portion and a wiping portion, wherein the fixing portion is fixed to the support unit;
a base made of plastic and having a main body, wherein the base is disposed at the middle of the top face of the support unit, and the main body has a first fastening portion; and
an accessory unit having two side walls, wherein a second fastening portion corresponding to the first fastening portion is disposed at inner sides of the two side walls, the accessory unit is disposed on the base, the first fastening portion of the base and the second fastening portion of the accessory unit are fastened to each other, and the accessory unit is fastened to the base.

2. The wiper device according to claim 1, wherein the middle section of the support unit is formed with a plurality of fixing holes, the bottom portion of the main body has a plurality of blocks protruding therefrom, and the fixing blocks and the fixing holes are engaged.

3. The wiper device according to claim 1, wherein the first fastening portions is disposed at the top face or a side face of the main body.

4. The wiper device according to claim 1, wherein the first fastening portion is a fastening body, and the second fastening portion is a fastening groove.

5. The wiper device according to claim 4, wherein the first fastening portion is formed with a convex curved face, the second fastening portion is formed with a concave curved face, two ends of the concave curved face define an opening therebetween, and the convex curved face of the first fastening portion and the concave curved face of the second fastening portion are fastened to each other.

6. The wiper device according to claim 1, wherein the first fastening portion is a fastening groove, and the second fastening portion is a fastening body.

7. The wiper device according to claim 6, wherein the first fastening portion is formed with a concave curved face, two ends of the concave curved face define an opening therebetween, and the second fastening portion is formed with a convex curved face, and the concave curved face of the first fastening portion and the convex curved face of the second fastening portion are fastened to each other.

8. The wiper device according to claim 1, wherein the inner side of each of the side walls has two ribs, the two ribs define a guiding groove therebetween, and the two guiding grooves guide the main body to be placed between the two side walls.
